(19) United States
(12) Patent Application Publication
(10) Pub. No.: US 2013/0304752 A1
(43) Pub. Date: Nov. 14, 2013

(54) INTEGRATED ABSENCE RECORDING FOR A MULTI-TIER EMPLOYMENT MODEL

(71) Applicants: Surendra Nath. Nukala, Srinagar Colony (IN); Arindam Mandal, Midnapore (West) (IN)

(72) Inventors: Surendra Nath. Nukala, Srinagar Colony (IN); Arindam Mandal, Midnapore (West) (IN)

(73) Assignee: Oracle International Corporation, Redwood Shores, CA (US)

(21) Appl. No.: 13/466,668

(22) Filed: May 8, 2012

(51) Int. Cl. G06F 17/30

(52) U.S. Cl. 707/754; 707/E17.059

(57) ABSTRACT

Embodiments of the invention provide systems and methods for recording and handling an absence of an individual according to a multi-tier employment model. According to one embodiment, the method can comprise receiving absence information indicating a period during which an individual will be unavailable. A list of assignments affected by the absence can be generated based on the received absence information, work schedule information, and work assignment information defined in a work assignment tier of the multi-tier employment model. The generated list of assignments can be filtered based on the received absence information and work schedule information for each assignment of the list of assignments. A list of supervisors corresponding to the assignments of the filtered list of assignments can be generated and a notification of the absence can be provided to each of the supervisors in the list of supervisors.

### BACKGROUND OF THE INVENTION

Embodiments of the present invention relate generally to methods and systems for resource planning and management and more particularly to recording and handling an absence of an individual according to a multi-tier employment model.

Traditional absence recording systems, such as may be utilized in an Enterprise Resource Planning (ERP) or other application for planning and managing resources, capture worker absences at an individual assignment (or job) level. Some systems support absence recording only at the primary assignment level. So for example, when an individual will be absent, that individual will use an absence recording feature of the ERP or other application to record an absence or otherwise indicate unavailability for work assignments, the individual must do so for each assignment for which they are scheduled during the planned absence period. However, users want to record absences for all of the assignments at one time instead of recording one for each assignment, or one for each reporting manager, or one for each legislation that their assignments belong to. Changing trends in the employment model, especially the introduction of multi-tier employment model in which individuals can be assigned to different responsibilities, in different roles, and with different working terms, add further ambiguity and degrades the user experience of traditional models of absence applications. Hence, there is a need for improved methods and systems for recording and handling an absence of an individual according to a multi-tier employment model.

### BRIEF SUMMARY OF THE INVENTION

Embodiments of the invention provide systems and methods for recording and handling an absence of an individual according to a multi-tier employment model. According to one embodiment, recording an absence according to a multi-tier employment model can comprising receiving absence information for an individual. The absence information can indicate an absence period during which the individual will be unavailable for work assignments. A list of assignments affected by the absence can be generated based on the received absence information for the individual, work schedule information for the individual, and work assignment information for the individual defined in a work assignment tier of the multi-tier employment model. The generated list of assignments can be filtered based on the received absence information and work schedule information for each assignment of the list of assignments. A list of supervisors corresponding to the assignments of the filtered list of assignments can be generated and a notification of the absence can be provided to each of the supervisors in the list of supervisors.

Generating the list of assignments affected by the absence and filtering the generated list of assignments can comprise, determining whether the absence period occurs within an assignment period defined in the work assignment tier of the multi-tier employment model. In response to determining the absence period occurs within the assignment period defined in the work assignment tier of the multi-tier employment model, an assignment schedule can be generated and a determination can be made as to whether the absence occurs within the generated assignment schedule. In response to determining the absence occurs within the generated assignment schedule, the assignment can be added to the list of assignments. Generating the assignment schedule can be based on the assignment period information of the work assignment tier of the multi-tier employment model, one or more work terms defined for the individual in a work terms tier of the multi-tier employment model, and one or more services defined for the individual in a work relationship tier of the multi-tier employment model. Generating the list of assignments affected by the absence and filtering the generated list of assignments can be repeated until all active assignments for the individual defined in the work assignment tier of the multi-tier employment model have been checked. Then, the list of assignments can be presented to the individual, an indication of a selection of one or more of the assignments on the list for which a notification should be made can be received, and the list of assignments can be filtered based on the received indications.

Providing a notification of the absence to each of the supervisors in the list of supervisors can comprise reading a set of one or more approval rules. An assignment level notification can be prepared for each of the assignments of the filtered list of assignments based on the approval rules. The assignment level notifications can be aggregated based on the list of supervisors and the aggregated assignment level notifications can be sent to the supervisors of the list of supervisors. In some cases, a determination can be made as to whether an approval has been received for each of the assignment level notifications. In response to determining an approval has not been received for each of the assignment level notifications, the approval notifications for which an approval has not been received can be resent. In some cases, prior to preparing the assignment level notifications, a determination can be made as to whether an automatic approval is permitted for the individual. In response to determining the automatic approval is permitted, an approval for the absence can be stored without preparing the assignment level notifications, aggregating the assignment level notifications, or sending the assignment level notifications.

### BRIEF DESCRIPTION OF THE DRAWINGS

FIG. 1 is a block diagram illustrating components of an exemplary operating environment in which various embodiments of the present invention may be implemented.

FIG. 2 is a block diagram illustrating an exemplary computer system in which embodiments of the present invention may be implemented.

FIG. 3 is a block diagram illustrating, at a high-level, functional components of a system for absence recording in a multi-tier employment model according to one embodiment of the present invention.

FIG. 4 is a block diagram illustrating exemplary multi-tier employment model information and work schedule information as may be used with embodiments of the present invention.

FIG. 5 is a block diagram illustrating exemplary work schedule and absence recording information in the exemplary multi-tier employment model and work schedule information of FIG. 4

FIG. 6 is a flowchart illustrating a process for absence recording according to one embodiment of the present invention.

FIG. 7 is a flowchart illustrating a process for generating a list of assignments for absence recording according to one embodiment of the present invention.

FIG. 8 is a flowchart illustrating a process for generating and tracking absence notifications according to one embodiment of the present invention.

### DETAILED DESCRIPTION OF THE INVENTION

In the following description, for the purposes of explanation, numerous specific details are set forth in order to provide a thorough understanding of various embodiments of the present invention. It will be apparent, however, to one skilled in the art that embodiments of the present invention may be practiced without some of these specific details. In other instances, well-known structures and devices are shown in block diagram form.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the invention as set forth in the appended claims.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

The term “machine-readable medium” includes, but is not limited to portable or fixed storage devices, optical storage devices, wireless channels and various other mediums capable of storing, containing or carrying instruction(s) and/or data. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine readable medium. A processor(s) may perform the necessary tasks.

Embodiments of the invention provide systems and methods for recording and handling an absence of an individual according to a multi-tier employment model. More specifically, embodiments of the present invention provide for processing the worker's employment, work schedule, and job information defined under the multi-tier employment model and determining the assignments that the absence will have an impact on. Based on start-date-and-time and end-date-and-time values that the user provides, embodiments described herein can determine the employment and assignment information instead of mandating users to enter absences for each assignment individually. Also, based on work schedule information available against each assignment, embodiments described herein can derive the absence duration automatically. The corresponding assignment supervisors can be notified and approvals of the notifications can be tracked accordingly. Various additional details of embodiments of the present invention will be described below with reference to the figures.

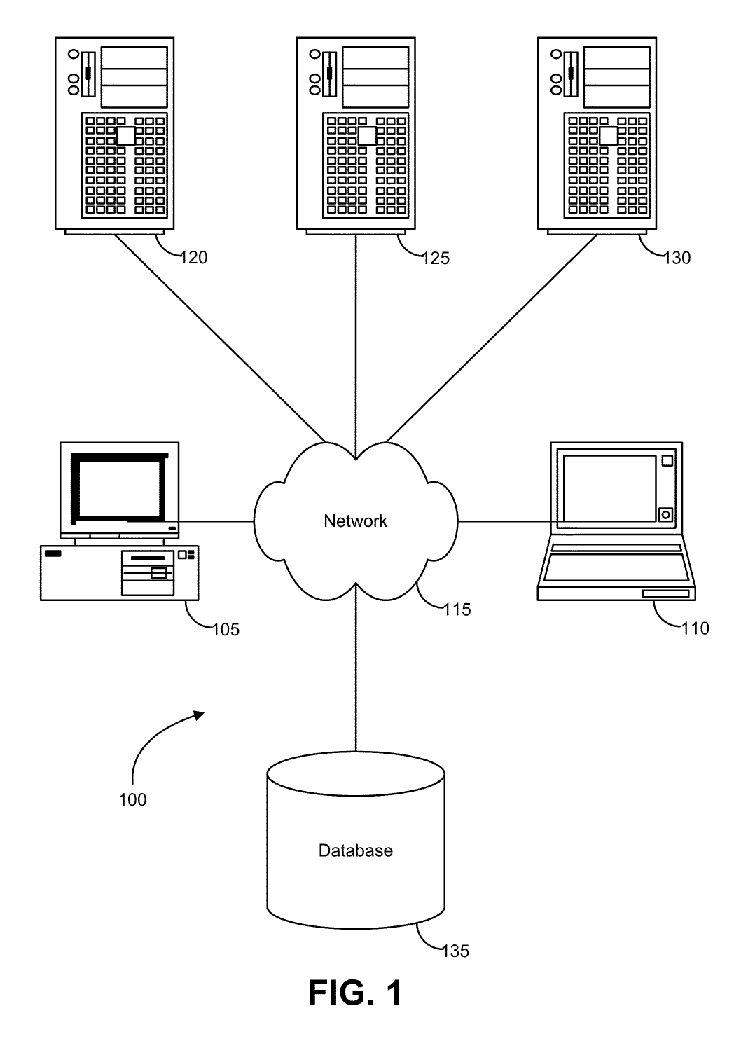

FIG. 1 is a block diagram illustrating components of an exemplary operating environment in which various embodiments of the present invention may be implemented. The system 100 can include one or more user computers 105, 110, which may be used to operate a client, whether a dedicate application, web browser, etc. The user computers 105, 110 can be general purpose personal computers (including, merely by way of example, personal computers and/or laptop computers running various versions of Microsoft Corp.'s Windows and/or Apple Corp.'s Macintosh operating systems) and/or workstation computers running any of a variety of commercially-available UNIX or UNIX-like operating systems (including without limitation, the variety of GNU/Linux operating systems). These user computers 105, 110 may also have any of a variety of applications, including one or more development systems, database client and/or server applications, and web browser applications. Alternatively, the user computers 105, 110 may be any other electronic device, such as a thin-client computer, Internet-enabled mobile telephone, and/or personal digital assistant, capable of communicating via a network (e.g., the network 115 described below) and/or displaying and navigating web pages or other types of electronic documents. Although the exemplary system 100 is shown with two user computers, any number of user computers may be supported.

In some embodiments, the system 100 may also include a network 115. The network may be any type of network familiar to those skilled in the art that can support data communications using any of a variety of commercially-available protocols, including without limitation TCP/IP, SNA, IPX, AppleTalk, and the like. Merely by way of example, the network 115 maybe a local area network (“LAN”), such as an Ethernet network, a Token-Ring network and/or the like; a wide-area network; a virtual network, including without limitation a virtual private network (“VPN”); the Internet; an intranet; an extranet; a public switched telephone network (“PSTN”); an infra-red network; a wireless network (e.g., a network operating under any of the IEEE 802.11 suite of protocols, the Bluetooth protocol known in the art, and/or any other wireless protocol); and/or any combination of these and/or other networks such as GSM, GPRS, EDGE, UMTS, 3G, 2.5 G, CDMA, CDMA2000, WCDMA, EVDO etc.

The system may also include one or more server computers 120, 125, 130 which can be general purpose computers and/or specialized server computers (including, merely by way of example, PC servers, UNIX servers, mid-range servers, mainframe computers rack-mounted servers, etc.). One or more of the servers (e.g., 130) may be dedicated to running applications, such as a business application, a web server, application server, etc. Such servers may be used to process requests from user computers 105, 110. The applications can also include any number of applications for controlling access to resources of the servers 120, 125, 130.

The web server can be running an operating system including any of those discussed above, as well as any commercially-available server operating systems. The web server can also run any of a variety of server applications and/or mid-tier applications, including HTTP servers, FTP servers, CGI servers, database servers, Java servers, business applications, and the like. The server(s) also may be one or more computers which can be capable of executing programs or scripts in response to the user computers 105, 110. As one example, a server may execute one or more web applications. The web application may be implemented as one or more scripts or programs written in any programming language, such as Java™, C, C# or C++, and/or any scripting language, such as Perl, Python, or TCL, as well as combinations of any programming/scripting languages. The server(s) may also include database servers, including without limitation those commercially available from Oracle®, Microsoft®, Sybase®, IBM® and the like, which can process requests from database clients running on a user computer 105, 110.

In some embodiments, an application server may create web pages dynamically for displaying on an end-user (client) system. The web pages created by the web application server may be forwarded to a user computer 105 via a web server. Similarly, the web server can receive web page requests and/or input data from a user computer and can forward the web page requests and/or input data to an application and/or a database server. Those skilled in the art will recognize that the functions described with respect to various types of servers may be performed by a single server and/or a plurality of specialized servers, depending on implementation-specific needs and parameters.

The system 100 may also include one or more databases 135. The database(s) 135 may reside in a variety of locations. By way of example, a database 135 may reside on a storage medium local to (and/or resident in) one or more of the computers 105, 110, 115, 125, 130. Alternatively, it may be remote from any or all of the computers 105, 110, 115, 125, 130, and/or in communication (e.g., via the network 120) with one or more of these. In a particular set of embodiments, the database 135 may reside in a storage-area network (“SAN”) familiar to those skilled in the art. Similarly, any necessary files for performing the functions attributed to the computers 105, 110, 115, 125, 130 may be stored locally on the respective computer and/or remotely, as appropriate. In one set of embodiments, the database 135 may be a relational database, such as Oracle 10g, that is adapted to store, update, and retrieve data in response to SQL-formatted commands.

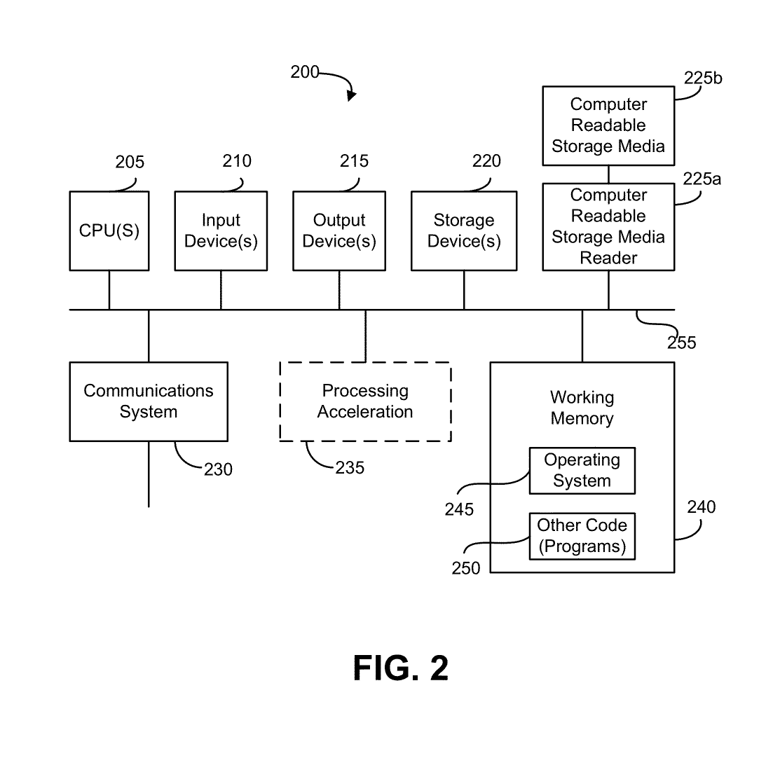

FIG. 2 illustrates an exemplary computer system 200, in which various embodiments of the present invention may be implemented. The system 200 may be used to implement any of the computer systems described above. The computer system 200 is shown comprising hardware elements that may be electrically coupled via a bus 255. The hardware elements may include one or more central processing units (CPUs) 205, one or more input devices 210 (e.g., a mouse, a keyboard, etc.), and one or more output devices 215 (e.g., a display device, a printer, etc.). The computer system 200 may also include one or more storage device 220. By way of example, storage device(s) 220 may be disk drives, optical storage devices, solid-state storage device such as a random access memory (“RAM”) and/or a read-only memory (“ROM”), which can be programmable, flash-updateable and/or the like.

The computer system 200 may additionally include a computer-readable storage media reader 225a, a communications system 230 (e.g., a modem, a network card (wireless or wired), an infra-red communication device, etc.), and working memory 240, which may include RAM and ROM devices as described above. In some embodiments, the computer system 200 may also include a processing acceleration unit 235, which can include a DSP, a special-purpose processor and/or the like.

The computer-readable storage media reader 225a can further be connected to a computer-readable storage medium 225b, together (and, optionally, in combination with storage device(s) 220) comprehensively representing remote, local, fixed, and/or removable storage devices plus storage media for temporarily and/or more permanently containing computer-readable information. The communications system 230 may permit data to be exchanged with the network 220 and/or any other computer described above with respect to the system 200.

The computer system 200 may also comprise software elements, shown as being currently located within a working memory 240, including an operating system 245 and/or other code 250, such as an application program (which may be a client application, web browser, mid-tier application, RDBMS, etc.). It should be appreciated that alternate embodiments of a computer system 200 may have numerous variations from that described above. For example, customized hardware might also be used and/or particular elements might be implemented in hardware, software (including portable software, such as applets), or both. Further, connection to other computing devices such as network input/output devices may be employed. Software of computer system 200 may include code 250 for implementing embodiments of the present invention as described herein.

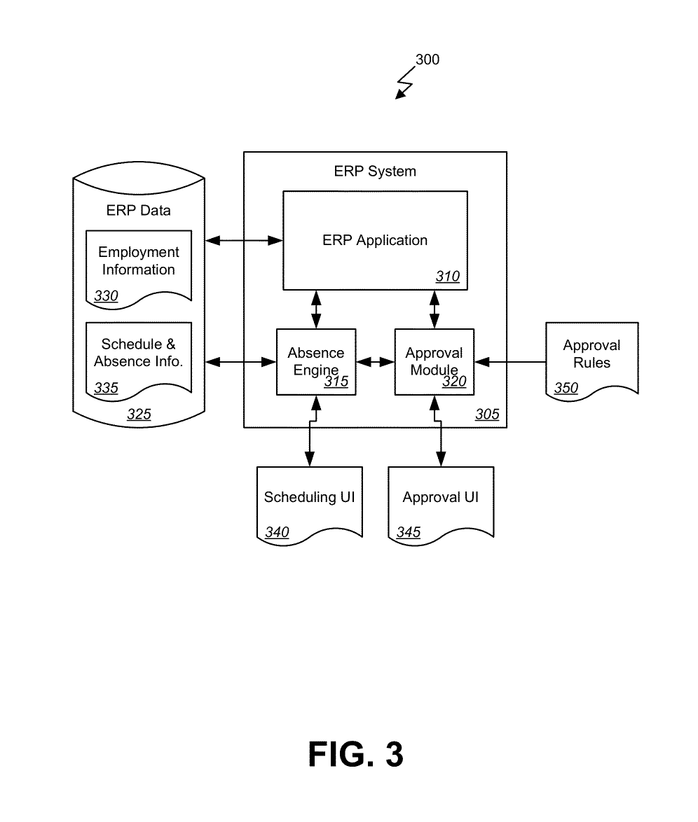

FIG. 3 is a block diagram illustrating, at a high-level, functional components of a system for absence recording under a multi-tier employment model according to one embodiment of the present invention. In this example, the system 300 can include a server or other computer as described above executing an Enterprise Resource Planning (ERP) application 310 and hence referred to here as the ERP system 305. However, it should be noted that, in other implementations, embodiments of the present invention can be implemented with other types of applications for managing resources, projects, schedules, etc. Thus, embodiments of the present invention are described in the context of an ERP application 310 only by way of example and not limitation.

The system 300 can also include a database or other repository 325 in which the ERP application 310 can maintain a set of data including but not limited to employment information 330 and schedule and absence information 335. The employment information can include a wide variety of information according to a multi-tier employment model such as will be described below. Generally speaking, such a model and the employment information 330 thereof can define various roles and responsibilities, work terms, assignments, etc. for any number of employees, contractors, or other individuals. The ERP system 305 can include an absence engine 315 providing a scheduling user interface 340. Through this interface 340, the employees, contractors, and other individuals can view schedule information and enter information regarding absences such as times, dates, etc. of periods of unavailability. An approval module 320 of the ERP system 305 can, based on a set of approval rules 350, in turn generate an approval user interface through which managers, supervisors, or other parties can approval or deny a requested absence.

Generally speaking, based on the start and end time of the absence received through the scheduling user interface 340, the absence engine 315 can determine a list of assignments that the absence has an impact on. The absence engine 315 can further filter the assignment list based on the assignment's work schedules by comparing the work schedules against the absence start and end dates and times and filter the assignments that are not in the absence time frame. For the assignments identified and based on the start and end time that was entered for the absence, the absence engine 315 can also derive a list of supervisors that correspond to each assignment. Supervisors identified in the list can then be notified by approval module 320 with the details of assignments that they supervise. When the supervisors approve the assignment-level absence information through the approval user interface 345, the approval module 320 and/or absence engine 315 can store an absence record in the schedule and absence information 335 of the database 325 with the appropriate final approval status. In some cases, approval rules 350 may be defined indicating that some or all approvals are mandatory or optional. In other words, even if one of the assignment supervisors rejects the absence, it can still be either considered as approved or rejected as a whole.

As noted above, handling the absence information is based in part on the employment information 330 which in turn is defined and maintained according to a multi-tier employment model. Examples of such a model and possible employment information of that model are described here for the sake of illustrate. However, these examples should not be considered limiting. Rather, depending upon the exact implementation and data used, the employment information 330 and even the model itself can vary significantly in both content and scope without departing from the scope of the present invention.

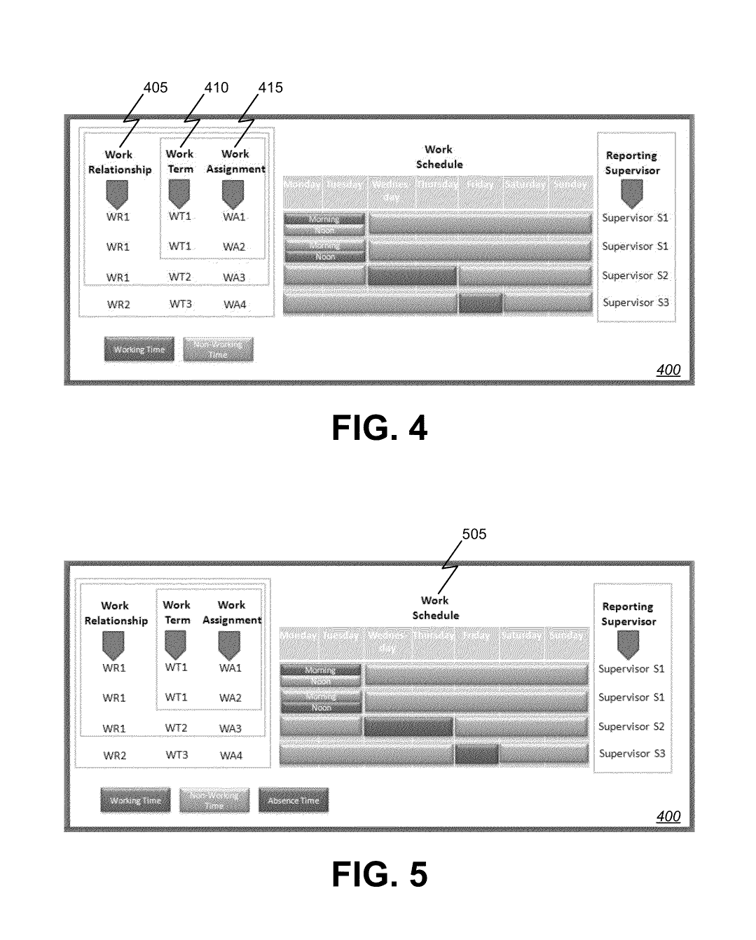

FIG. 4 is a block diagram illustrating exemplary multi-tier employment model information as may be used with embodiments of the present invention. This example includes a graphical representation 400 of the model as may be presented in the user interfaces 340 and 345 described above but which more generally represents the exemplary model conceptually. In this example, the multi-tier employment model consists of 3 levels, namely, the work relationship tier 405, the work term tier 410 and the work assignment tier 415. The work relationship tier 405 can provide details of the service of the worker with the hiring legal entity. A worker can have multiple such work relationships with an employer. The work terms tier 410 can provide the details of the terms agreed by the worker and employer under a work relationship. A worker can have multiple work terms under a work relation with an employer. The work assignments tier 415 provides the details of the work responsibilities, job and grade details, payroll information and project details, etc. assigned to the worker. An employee can have the same or different supervisors supervising their various assignments. As illustrated here, the current employee has supervisor S1 supervising both WA1 and WA2. Whereas, supervisor S2 is supervising WA3 and supervisor S3 is supervising WA4 respectively.

For example, an employee can have two work relationships with ABC Corporation. (WR1 with ‘ABC US’ division and WR2 with ‘ABC Canada’ division). This employee can also have two work terms for WR1. (WT1 for ‘ABC US Marketing’ division and WT2 for ‘ABC US Procurement’ division). As illustrated here, work term WT1 has two assignments (WA1, WA2 for ‘ABC US Marketing Accounts’ and ‘ABC US Marketing Sales’ divisions respectively). Also as illustrated here, the work relationship with ABC Canada division has one work term (WT3) and one Assignment (WA4) for the training work that the employee undertakes for the ‘ABC Canada’ sales teams.

FIG. 5 is a block diagram illustrating exemplary work schedule and absence recording information in the exemplary multi-tier employment model of FIG. 4. This example includes the same graphical representation 400 of the multi-tier employment model including the work schedule information 505 which can indicate the times and days for which the individual worker is scheduled to work on or be available for the various work assignments of the work assignment tier 415. So for example, the employee can be scheduled to work on Monday and Tuesday morning sessions for ABC US Marketing Accounts (WA1), Monday and Tuesday afternoon sessions for ABC US Marketing Sales (WA2), Wednesday and Thursday for ABC US Procurement division (WA3), and Friday for ABC Canada to train sales force (WA4).

Continuing with the examples provided in FIGS. 4 and 5 but returning to FIG. 3, the absence engine 315 of the ERP system 305 can derive list of assignments based on absence dates and work schedules and route approval notifications to assignment-level supervisors, aggregating the notifications where appropriate and tracking the outcome of approval notification statuses. Suppose, for example, that the employee mentioned above is going on leave from Monday to Friday of a particular week as represented by the schedule 505 above. According an embodiment of the present invention, rather than the employee applying for leave four times; that is, one for each assignment, the employee can apply for leave in one go, for all of the assignments irrespective of the actual number of assignments that the employee is working on, the legislations that those assignments belong to, or the supervisors that the employee is reporting to under those assignments.

When the employee enters the start date and end date (including time) through the scheduling user interface 340, the absence engine 315 can obtain the list of assignments that the recorded absence will have an impact on. For example, in the above case, if the employee enters Monday morning as the start of the absence and Friday evening as the end of the absence, then that indicates that all of the assignments (WA1, WA2, WA3, and WA4) are impacted by the absence. At the same time, the assignment list can be derived by the absence engine 315 on the basis of the work schedule information 335 that the assignments are assigned to. For example, in the above scenario, if the employee is going on leave from Tuesday afternoon to Friday evening, there is no need to display WA1 to the employee as that will not have any impact of the current absence record. So, the system can filter out WA1 before displaying the assignment list to the user if an absence is being recorded from Tuesday afternoon to Friday evening. In this way, its processing can be seamless to employees.

The absence engine 315 can then identify the appropriate assignment supervisors who are affected by the current absence record, generate notifications for each of those supervisors, aggregate the notifications where it is possible or appropriate (in case of multiple assignments under the same supervisor), send the aggregated notifications to those supervisors, track the notification approval status, and record the outcome based on approval rules 350. So in the above example, suppose that the employee applies leave from Monday to Tuesday, then the system can identify the assignments (WA1 and WA2) that are affected by this absence record, identify the fact that both the assignments have the same manager (Supervisor S1), and send a single aggregated notification to the manager for both the assignments. In case the employee applies for leave from Wednesday to Friday, both the Managers (Supervisors S2 and S3) can be notified separately with their respective assignment details. According to one embodiment, if one manager (say S2) approves the absence but another manager (say S3) rejects, then the outcome can be determined and stored in the database appropriately based on the approval rules 350.

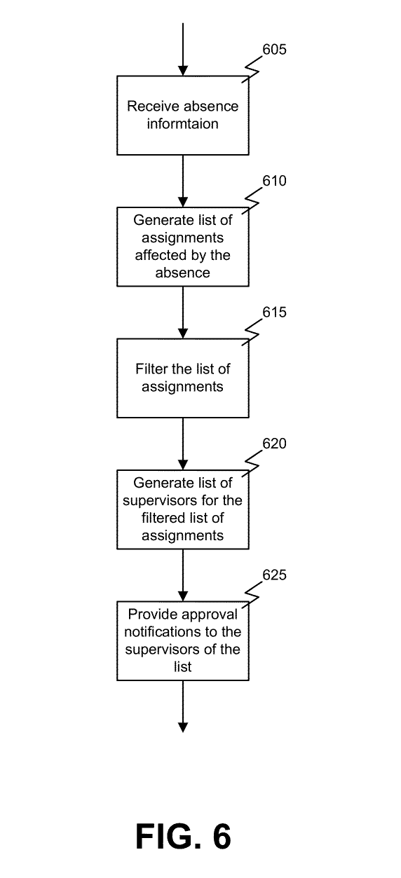

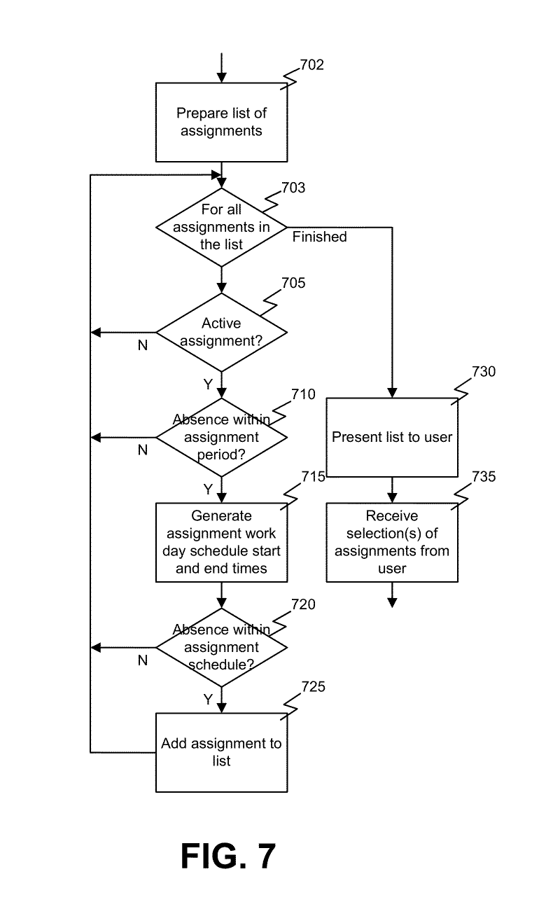

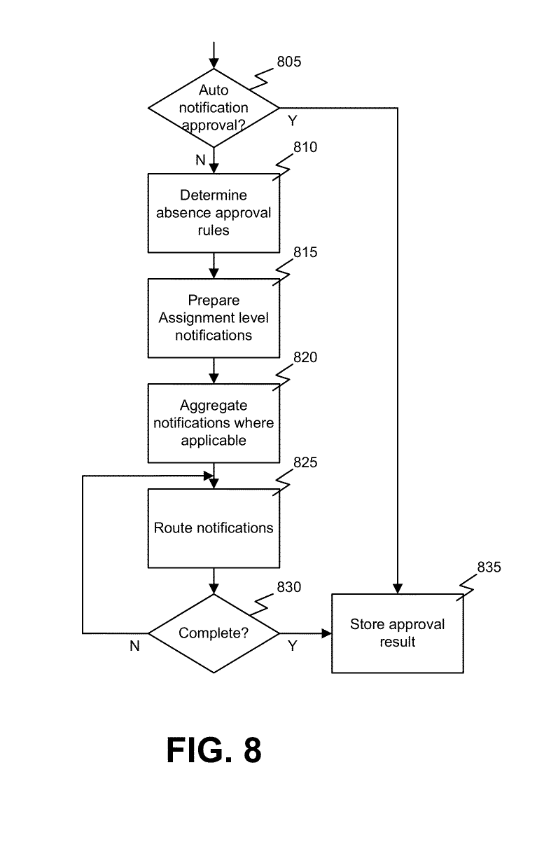

FIG. 6 is a flowchart illustrating a process for absence recording according to one embodiment of the present invention. In this example, recording an absence in a multi-tier employment model can comprise receiving 605 absence information for an individual. The absence information can indicate an absence period during which the individual will be unavailable for work assignments. A list of assignments affected by the absence can be generating 610 based on the received absence information for the individual, work schedule information for the individual, and work assignment information for the individual defined in a work assignment tier of the multi-tier employment model. The generated list of assignments can be filtering 615 based on the received absence information and schedule information for each assignment of the list of assignments. Additional details of a process for generating 610 and filtering 615 a list of assignments affected by the absence will be described below with reference to FIG. 7. A list of supervisors corresponding to the assignments of the filtered list of assignments can be generated 620 and a notification of the absence can be provided 625 to each of the supervisors in the list of supervisors. Additional details of a process for providing 625 a notification to each of the supervisors will be described below with reference to FIG. 8.

FIG. 7 is a flowchart illustrating a process for generating a list of assignments for absence recording according to one embodiment of the present invention. In this example, generating the list of assignments affected by the absence and filtering the generated list of assignments can comprise preparing 702 the list of assignments and iterating 703 through the list to find active assignments impacted by the absence. More specifically, for 703 each assignment on the list, a determination 705 can be made as to whether the assignment is active. In response to determining 705 the assignment active, a determination 710 can be made as to whether the absence period occurs within an assignment period defined in the work assignment tier of the multi-tier employment model.

In response to determining 710 the absence period occurs within the assignment period defined in the work assignment tier of the multi-tier employment model, an assignment schedule can be generated 715. For example, the assignment schedule can indicate start and stop times, days, etc. during which the individual is scheduled to work on a particular assignment. Generating 715 such an assignment schedule can be based on the assignment period information of the work assignment tier of the multi-tier employment model, one or more work terms defined for the individual in a work terms tier of the multi-tier employment model, and one or more services defined for the individual in a work relationship tier of the multi-tier employment model.

A determination 720 can then be made as to whether the absence occurs within the generated assignment schedule. In response to determining 720 the absence occurs within the generated assignment schedule, the assignment can be added 725 to the list of assignments. Generating the list of assignments affected by the absence and filtering the generated list of assignments until a determination 705 is made that all active assignments for the individual have defined in the work assignment tier of the multi-tier employment model have been checked.

Once the determination 703 is made that all assignments have been checked, i.e., the process has finished iterating 703 through the list to find active assignments impacted by the absence, the list of assignments can be presented 730 to the individual, e.g., through an absence recording user interface such as described above. An indication of a selection of one or more of the assignments on the list for which absence can be recorded and notifications should be sent can be received 735. For example, the individual can select all or some subset less than all of the assignments to indicate or acknowledge that notice of the absence should be given to the supervisor of that assignment. In other words, the list of assignments can be further filtered based on the received indications from the individual who is recording the absence.

FIG. 8 is a flowchart illustrating a process for generating and tracking absence notifications according to one embodiment of the present invention. In this example, providing a notification of the absence to each of the supervisors in the list of supervisors can begin with making a determination 805 as to whether automatic absence approval is enabled for the individual, e.g., based on the individual's employment information like job, grade, position, etc., or based on the absence approval rules setup in the approval system. In response to determining 805 the automatic approval is not enabled in the approvals system, a set of one or more approval rules can be read 810 and an assignment level notification can be prepared 815 for each of the assignments of the filtered list of assignments based on the approval rules. For example, these rules can define if all maternity type absence requests can be automatically approved, or if 3 levels of approvals are required for an education leave, or human resources administrator's approval is required in addition to supervisor's approval for sick leave and so on.

The assignment level notifications can be aggregated 820 based on the list of supervisors. That is, common notifications to the same supervisor can be identified and combined or eliminated to reduce duplications or redundancies in the notifications. The aggregated notification can provide the details of one or more assignments that the current absence is being recorded, where the Supervisor is same. The aggregated or individual assignment level notifications, based on the setup created in approvals system, can be sent 825 to the supervisors of the list of supervisors. After the notifications have been sent 825, for example after the passage of a predetermined amount of time or based on other conditions, a determination 830 can be made as to whether an approval or denial has been received for each of the notifications sent out to supervisors. In response to determining 830 an approval or denial has not been received for each of the notifications sent out, the approval notifications for which an approval has not been received can be resent 825 until an approval or denial has been received. Using approvals rules engine, rules may be setup, for example, to indicate if any of the supervisors that have received the notifications rejects the absence requested for their reporting assignment, then whether the absence has to be considered as rejected or partially approved for the corresponding remaining approved assignments.

As noted, prior to preparing the assignment level notifications, a determination 805 whether an automatic approval is permitted for the individual. In response to determining 805 the automatic approval is permitted, an approval for the absence can be stored 835. That is, if permitted for the individual based on the individuals status, position, or other conditions, an approval can be indicated and stored 835 without preparing 815 the assignment level notifications, aggregating 820 the assignment level notifications, or sending 825 the aggregated assignment level notifications.

In the foregoing description, for the purposes of illustration, methods were described in a particular order. It should be appreciated that in alternate embodiments, the methods may be performed in a different order than that described. It should also be appreciated that the methods described above may be performed by hardware components or may be embodied in sequences of machine-executable instructions, which may be used to cause a machine, such as a general-purpose or special-purpose processor or logic circuits programmed with the instructions to perform the methods. These machine-executable instructions may be stored on one or more machine readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

While illustrative and presently preferred embodiments of the invention have been described in detail herein, it is to be understood that the inventive concepts may be otherwise variously embodied and employed, and that the appended claims are intended to be construed to include such variations, except as limited by the prior art.

1. A method for recording an absence according to a multi-tier employment model, the method comprising:
receiving absence information for an individual, the absence information indicating an absence period during which the individual will be unavailable for work assignments;
generating a list of assignments the individual is assigned to work on and which are affected by the absence based on the received absence information for the individual, work schedule information for the individual, and the multi-tier employment model, the multi-tier employment model comprising one or more work terms defined for the individual in a work terms tier of the multi-tier employment model, one or more services defined for the individual in a work relationship tier of the multi-tier employment model, and work assignment information for the individual defined in a work assignment tier of the multi-tier employment model;
filtering the generated list of assignments based on the received absence information and work schedule information for each assignment of the list of assignments;
generating a list of supervisors corresponding to the assignments of the filtered list of assignments; and
providing a notification of the absence to each of the supervisors in the list of supervisors.

2. The method of claim 1, wherein generating the list of assignments affected by the absence and filtering the generated list of assignments further comprises:
determining whether the absence period occurs within an assignment period defined in the work assignment tier of the multi-tier employment model;
in response to determining the absence period occurs within the assignment period defined in the work assignment tier of the multi-tier employment model, generating an assignment schedule and determining whether the absence occurs within the generated assignment schedule; and
in response to determining the absence occurs within the generated assignment schedule, adding the assignment to the list of assignments.

3. The method of claim 2, wherein generating the assignment schedule is based on the assignment period information of the work assignment tier of the multi-tier employment model, the one or more work terms defined for the individual in the work terms tier of the multi-tier employment model, and the one or more services defined for the individual in the work relationship tier of the multi-tier employment model.

4. The method of claim 2, further comprising repeating said generating the list of assignments affected by the absence and filtering the generated list of assignments until all active assignments for the individual have defined in the work assignment tier of the multi-tier employment model have been checked.

5. The method of claim 4, further comprising:
presenting the list of assignments to the individual;
receiving an indication of a selection of one or more of the assignments on the list for which a notification should be made; and
filtering the list of assignments based on the received indications.

6. The method of claim 1, wherein providing a notification of the absence to each of the supervisors in the list of supervisors comprises:
reading a set of one or more approval rules;
preparing an assignment level notification for each of the assignments of the filtered list of assignments based on the approval rules;
aggregating the assignment level notifications based on the list of supervisors; and
sending the aggregated assignment level notifications to the supervisors of the list of supervisors.

7. The method of claim 6, further comprising:
determining whether an approval has been received for each of the assignment level notifications; and
in response to determining an approval has not been received for each of the assignment level notifications, resending the approval notifications for which an approval has not been received.

8. The method of claim 6, further comprising, prior to preparing the assignment level notifications, determining whether an automatic approval is permitted for the individual and, in response to determining the automatic approval is permitted, storing an approval for the absence without preparing the assignment level notifications, aggregating the assignment level notifications, or sending the assignment level notifications.

9. A system comprising:
a processor; and
a memory coupled with the processor and having stored therein a sequence of instructions which, when executed by the processor, cause the processor to record an absence according to a multi-tier employment model by receiving absence information for an individual, the absence information indicating an absence period during which the individual will be unavailable for work assignments, generating a list of assignments the individual is assigned to work on and which are affected by the absence based on the received absence information for the individual, work schedule information for the individual, and the multi-tier employment model, the multi-tier employment model comprising one or more work terms defined for the individual in a work terms tier of the multi-tier employment model, one or more services defined for the individual in a work relationship tier of the multi-tier employment model, and work assignment information for the individual defined in a work assignment tier of the multi-tier employment model, filtering the generated list of assignments based on the received absence information and work schedule information for each assignment of the list of assignments, generating a list of supervisors corresponding to the assignments of the filtered list of assignments, and providing a notification of the absence to each of the supervisors in the list of supervisors.

10. The system of claim 9, wherein generating the list of assignments affected by the absence and filtering the generated list of assignments further comprises:
determining whether the absence period occurs within an assignment period defined in the work assignment tier of the multi-tier employment model;
in response to determining the absence period occurs within the assignment period defined in the work assignment tier of the multi-tier employment model, generating an assignment schedule and determining whether the absence occurs within the generated assignment schedule, wherein generating the assignment schedule is based on the assignment period information of the work assignment tier of the multi-tier employment model, the one or more work terms defined for the individual in the work terms tier of the multi-tier employment model, and the one or more services defined for the individual in the work relationship tier of the multi-tier employment model;
in response to determining the absence occurs within the generated assignment schedule, adding the assignment to the list of assignments; and
repeating said generating the list of assignments affected by the absence and filtering the generated list of assignments until all active assignments for the individual have defined in the work assignment tier of the multi-tier employment model have been checked.

11. The system of claim 10, further comprising:
presenting the list of assignments to the individual;
receiving an indication of a selection of one or more of the assignments on the list for which a notification should be made; and
filtering the list of assignments based on the received indications.

12. The system of claim 9, wherein providing a notification of the absence to each of the supervisors in the list of supervisors comprises:
reading a set of one or more approval rules;
preparing an assignment level notification for each of the assignments of the filtered list of assignments based on the approval rules;
aggregating the assignment level notifications based on the list of supervisors; and
sending the aggregated assignment level notifications to the supervisors of the list of supervisors.

13. The system of claim 12, further comprising:
determining whether an approval has been received for each of the assignment level notifications; and
in response to determining an approval has not been received for each of the assignment level notifications, resending the approval notifications for which an approval has not been received.

14. The system of claim 12, further comprising, prior to preparing the assignment level notifications, determining whether an automatic approval is permitted for the individual and, in response to determining the automatic approval is permitted, storing an approval for the absence without preparing the assignment level notifications, aggregating the assignment level notifications, or sending the assignment level notifications.

15. A computer-readable memory device comprising a set of instructions stored thereon which, when executed by a processor, causes the processor to record an absence according to a multi-tier employment model by:
receiving absence information for an individual, the absence information indicating an absence period during which the individual will be unavailable for work assignments;
generating a list of assignments the individual is assigned to work on and which are affected by the absence based on the received absence information for the individual, work schedule information for the individual, and the multi-tier employment model, the multi-tier employment model comprising one or more work terms defined for the individual in a work terms tier of the multi-tier employment model, one or more services defined for the individual in a work relationship tier of the multi-tier employment model, and work assignment information for the individual defined in a work assignment tier of the multi-tier employment model;
filtering the generated list of assignments based on the received absence information and work schedule information for each assignment of the list of assignments;
generating a list of supervisors corresponding to the assignments of the filtered list of assignments; and
providing a notification of the absence to each of the supervisors in the list of supervisors.

16. The computer-readable memory device of claim 15, wherein generating the list of assignments affected by the absence and filtering the generated list of assignments further comprises:
determining whether the absence period occurs within an assignment period defined in the work assignment tier of the multi-tier employment model;
in response to determining the absence period occurs within the assignment period defined in the work assignment tier of the multi-tier employment model, generating an assignment schedule and determining whether the absence occurs within the generated assignment schedule, wherein generating the assignment schedule is based on the assignment period information of the work assignment tier of the multi-tier employment model, the one or more work terms defined for the individual in the work terms tier of the multi-tier employment model, and the one or more services defined for the individual in the work relationship tier of the multi-tier employment model;
in response to determining the absence occurs within the generated assignment schedule, adding the assignment to the list of assignments; and
repeating said generating the list of assignments affected by the absence and filtering the generated list of assignments until all active assignments for the individual have defined in the work assignment tier of the multi-tier employment model have been checked.

17. The computer-readable memory device of claim 16, further comprising:
presenting the list of assignments to the individual;
receiving an indication of a selection of one or more of the assignments on the list for which a notification should be made; and
filtering the list of assignments based on the received indications.

18. The computer-readable memory device of claim 15, wherein providing a notification of the absence to each of the supervisors in the list of supervisors comprises:
reading a set of one or more approval rules;
preparing an assignment level notification for each of the assignments of the filtered list of assignments based on the approval rules;
aggregating the assignment level notifications based on the list of supervisors; and
sending the aggregated assignment level notifications to the supervisors of the list of supervisors.

19. The computer-readable memory device of claim 18, further comprising:
determining whether an approval has been received for each of the assignment level notifications; and
in response to determining an approval has not been received for each of the assignment level notifications, resending the approval notifications for which an approval has not been received.

20. The computer-readable memory device of claim 18, further comprising, prior to preparing the assignment level notifications, determining whether an automatic approval is permitted for the individual and, in response to determining the automatic approval is permitted, storing an approval for the absence without preparing the assignment level notifications, aggregating the assignment level notifications, or sending the assignment level notifications.
